(19) United States
(12) Patent Application Publication
(10) Pub. No.: US 2016/0182639 A1
(43) Pub. Date: Jun. 23, 2016

(54) INTERNET OF THINGS NETWORK SYSTEM USING FOG COMPUTING NETWORK

(71) Applicant: UNIVERSITY-INDUSTRY COOPERATION GROUP OF KYUNG-HEE UNIVERSITY, Yongin-si (KR)

(72) Inventors: Choong Seon HONG, Yongin-si (KR); Sung Won LEE, Seongnam-si (KR); Fakhrul Abedin SARDER, Yongin-si (KR)

(73) Assignee: UNIVERSITY-INDUSTRY COOPERATION GROUP OF KYUNG-HEE UNIVERSITY, Yongin-si (KR)

(21) Appl. No.: 14/634,049

(22) Filed: Feb. 27, 2015

(30) Foreign Application Priority Data
Dec. 17, 2014 (KR) 10-2014-0182722

(51) Int. Cl. H04L 29/08; G06F 9/455; H04L 12/12

(52) U.S. Cl. CPC H04L 67/12; H04L 67/10; H04L 12/12; G06F 9/45558; G06F 2009/45595

(57) ABSTRACT

The present invention relates to an Internet of Things network system, and more particularly, to such an Internet of Things network system in which the installation and version management of an application of a virtual machine for operating a detection server device is performed through a fog computing network in response to a request from a manager so that an application specialized for the detection server device can be easily installed or managed through the fog computing network.

### CROSS-REFERENCE TO RELATED APPLICATIONS

This application claims the benefit of Korean Patent Application No. 10-2014-0182722, filed on Dec. 17, 2014 in the Korean Intellectual Property Office, which is incorporated herein by reference in its entirety.

### BACKGROUND OF THE INVENTION

1. Field of the Invention

The present invention relate to an Internet of Things network system, and more particularly, to such an Internet of Things network system in which the installation and version management of an application of a virtual machine for operating a detection server device is performed through a fog computing network in response to a request from a manager so that an application specialized for the detection server device can be easily installed or managed through the fog computing network, and in which an operation mode of the detection server device is controlled based on the operation state of the detection server device so that energy consumption can be reduced in the Internet of Things network environment where a vast amount of data is processed.

2. Description of Related Art

Cloud computing refers to a computer environment in which information is permanently stored in a server on the Internet and is temporarily stored in a client such as an IT device including a desktop, a tablet computer, a notebook computer, a netbook, a smart phone or the like. That is, the concept of the cloud computing is that all kinds of information on a user is stored in a cloud server on the Internet, and the information can be used through various IT devices anytime and anywhere.

In other words, the cloud computing is a computing service in which a user lends a desired computing resource such as a hardware/software existing in an intangible form like cloud in the sky and pays a charge for the lent computing resource. In addition, the cloud computing means a technology that integrates computing resources existing in different physical positions using a virtualization technology and provides them integrated computing resources to users. The cloud computing, which is an innovative computing technology providing IT-related services such as the storage and processing of data, the use of a network and contents, and the like at one time through a cloud server on the Internet represented by a cloud, is also defined as a “customized outsourcing service of IT resources using the Internet”. Such cloud computing also provides various application services besides a service of providing computing resources of a hardware/software for storing and processing data.

The introduction of the clouding computing can enable an enterprise or an individual to reduce exorbitant time, manpower, and costs such as the cost spent to maintain, repair and manage a computer system and the cost spent to purchase and install a server, the update cost, a software purchase cost, etc. In addition, the introduction of the clouding computing can contribute to energy saving and thus the cloud server can be widely used in a variety of fields.

In the meantime, recently, many researches are in progress on Internet of Things (IoT). The Internet of Things, which has been relatively revolved as compared to the Internet or a mobile Internet based on an existing wired communication, allows IT devices themselves connected to the Internet to transmit or receive information with each other without any intervention of persons and process the information. The Internet of Things is similar to the existing ubiquitous or machine to machine (M2M) in that physical objects or “things” perform a communication therebetween, but can be regarded as a technology that has been revolved to a concept that a concept of M2M mainly aimed to perform a communication between a communication device and a person is extended through the Internet so that the communication device interacts with things as well as all kinds of information on a reality world and a virtual world.

The key technical elements for implementing the Internet of Things include a ‘sensing technology’ in which information is obtained from tangible things and the surrounding environments, a ‘wired/wireless communication and network infrastructure technology’ which supports the connection of things to the Internet, and a ‘service interface technology’ which processes information so as to be suitable for various kinds of service fields and types or fuses various technologies. The amount of information acquired through the Internet of Things is very vast and the use of the cloud service is further needed to process the vast amount of information.

However, the conventional cloud computing entails a problem in that since the cloud computing is constructed by a plurality of cloud server providers and provides a various kinds of applications, it is excellent in terms of openness and diversity but the information or data processing time is delayed if a vast amount of information is transmitted through the connection with the Internet of Things or a vast amount of data are all processed in an application of the clouding computing.

Fog computing has been proposed to solve the above problem. The fog computing refers to a paradigm which extends the cloud computing and services to the edge of a network. The fog computing is similar to the cloud computing in terms of a concept that data, computing, storage and application services are provided to end users, but significantly distinguishes from the cloud computing in terms of its proximity to end users, its dense geographical distribution, and its support for mobility.

In other words, in the fog computing, services are hosted at the network edge or even end devices such as set-top boxes or access points. By hosting services at a near place, the delay of the services can be reduced according to the need or environment of a client and the quality of services can be improved.

Thus, in the case where the fog computing is incorporated into the Internet of Things, memories, computing resources, or application services are supplied through the proximity to an end device so that the delay of the time spent to process date can be reduced.

However, a service has not been proposed yet in which the fog computing and the Internet of Things are combined with each other. Furthermore, no research has been conducted on a technology in which application specialized for the end device is installed and managed by a fog computing network.

### SUMMARY OF THE INVENTION

Accordingly, the present invention has been made to solve the above-mentioned problems involved in the conventional block matching apparatus, and it is an object of the present invention to provide an Internet of Things network system in which the installation and version management of an application of a virtual machine for operating an end device or a detection server device can be easily performed in response to a request from a manager.

Another object of the present invention is to provide an Internet of Things network system in which whether or not there exists an application necessary for operation of a detection server device, and the version state and the operation state of the application is first tested, and then the application is installed in a virtual machine.

Still another object of the present invention is to provide a method for operating an Internet of Things network system in which an operation mode of a detection server device to be controlled based on the operation state of the detection server device so that energy consumption can be reduced.

To accomplish the above objects, in one aspect, the present invention provides an Internet of Things network system including: a fog computing network in which an application is implemented; and a detection server device including a plurality of detection sensors connected thereto and configured to transmit information collected to the fog communicating network in response to a request for the application.

Preferably, the fog computing network may include: a source unit configured to storing an application; an application management unit configured to, if there is a request from a user terminal for the application, test the implementation of the requested application; and a virtual machine unit configured to receive the requested application from the application management unit, and receive information from the detection server device to implement the requested application.

Preferably, the application management unit may include: an internal source unit configured to store an application therein; a determination unit configured to determine whether or not the requested application exists in the internal source unit, and provide the requested application to a virtual machine in which the requested application is executed; and an application request unit configured to request the requested application from the source unit if it is determined that the requested application does not exist in the internal source unit.

The application management unit may include a version comparison unit configured to compare a version of the requested application that exists in the internal source unit with a new version of the requested application that is stored in the source unit, and the version comparison unit may request the new version of the requested application from the source unit through the application request unit if the version of the requested application existing in the internal source unit is different from the new version of the requested application stored in the source unit.

Herein, the virtual machine unit may receive the requested application from the application management unit, and then periodically receive information on a new version of the requested application from the source unit.

Herein, the virtual machine unit may receive the new version of the requested application from the application management unit or the source unit when the virtual machine unit receives the information on the new version of the requested application from the source unit.

Preferably, the Internet of Things network system in accordance with an embodiment of the present invention may further include a cloud computing network that exists at an upper position of a plurality of fog computing networks that are distributed, wherein if the application does not exist in the fog computing network, the fog computing network receives the application from the cloud computing network.

Preferably, the detection server device may include: a plurality of detection sensors attached to things; and a detection server unit connected to the detection sensors, the detection server unit being configured to control the plurality of detection sensors to selectively perform a detection operation thereof in response to a request for the application to collect information and configured to transmit the collected information to a virtual machine unit.

Herein, each of the plurality of detection sensors may be allocated with an individual IP address, or the plurality of detection sensors may be divided into each group so that each sensor group is allocated with an IP address.

Herein, the detection server device may further include an energy management unit configured to implement the operation of the detection sensor in any one of an active mode, a standby mode, and an idle mode depending on whether or not there is a request from the virtual machine unit for information to control the energy consumption of the detection sensor.

Herein, the energy management unit may implement the operation of the detection sensor in the active mode to collect detection information through the detection sensor and transmit the collected the detection information to the virtual machine unit if there is a request from the virtual machine unit for information.

Herein, the energy management unit may implement the operation of the detection sensor in the standby mode to wait a re-detection command from the detection server unit and control the collection of the detection information by the detection sensor to be stopped if there is no request from the virtual machine unit for information during a first threshold time.

Herein, the energy management unit may implement the operation of the detection sensor in the idle mode if no re-detection command is received during a second threshold time in the standby mode.

Herein, when the operation of the detection sensor is implemented in the idle mode, the detection sensor may determine whether or not there is a change in detection environment, and if there is no change in the detection environment, the detection sensor is turned off.

Herein, the energy management unit may control the operation mode of the detection sensor to be changed to the standby mode if there is a change in the detection environment.

Herein, the energy management unit may turn on the detection sensor periodically to determine whether or not there is a change in the detection environment.

In another aspect, the present invention provides a detection server device configured to transmit detection information to a fog communicating network in response to a request for an application from the fog computing network in which the application is implemented, the detection server device including: a plurality of detection sensors attached to things; and a detection server unit connected to the detection sensors, the detection server unit being configured to control the plurality of detection sensors to selectively perform a detection operation thereof in response to a request for the application to collect information and configured to transmit the collected information to a virtual machine unit; and an energy management unit configured to implement the operation of the detection sensor in any one of an active mode, a standby mode, and an idle mode depending on whether or not there is a request from the virtual machine unit for information to control the energy consumption of the detection sensor.

Herein, the energy management unit may implement the operation of the detection sensor in the active mode to collect detection information through the detection sensor and transmit the collected the detection information to the virtual machine unit if there is a request from the virtual machine unit for information.

Herein, the energy management unit may implement the operation of the detection sensor in the standby mode to wait a re-detection command from the detection server unit and control the collection of the detection information by the detection sensor to be stopped if there is no request from the virtual machine unit for information during a first threshold time.

Herein, the energy management unit may implement the operation of the detection sensor in the idle mode if no re-detection command is received during a second threshold time in the standby mode.

Herein, when the operation of the detection sensor is implemented in the idle mode, the detection sensor may determine whether or not there is a change in detection environment, and if there is no change in the detection environment, the detection sensor is turned off.

Herein, the energy management unit may control the operation mode of the detection sensor to be changed to the standby mode if there is a change in the detection environment.

Herein, the energy management unit turns on the detection sensor periodically to determine whether or not there is a change in the detection environment.

### BRIEF DESCRIPTION OF THE DRAWINGS

The above and other objects, features and advantages of the present invention will be apparent from the following detailed description of the preferred exemplary embodiments of the invention in conjunction with the accompanying drawings, in which:

FIG. 1 is a functional block diagram showing an Internet of Things network system in accordance with the present invention;

FIG. 2 is a functional block diagram showing a fog computing network in accordance with an embodiment of the present invention;

FIG. 3 is a functional block diagram showing one example of an application management unit in accordance with the present invention;

FIG. 4 is a functional block diagram showing one example of a detection server device in accordance with the present invention;

FIG. 5 is a functional block diagram showing one example of an energy management unit in accordance with the present invention;

FIG. 6 is a flow chart showing one example of a method for controlling the operation mode of a detection sensor in accordance with the present invention; and

FIG. 7 is a flow chart showing one example of a method for controlling an idle mode of a detection sensor in accordance with the present invention.

### EXPLANATION ON SYMBOLS

100: cloud computing network
200: fog computing network
300: user terminal
400: detection server device
210: application management unit
230: source unit
250: virtual machine unit
211: determination unit
213: internal source unit
215: application request unit
217: version comparison unit
219: testing unit
410: detection server unit
430: detection server
450: energy management unit
451: standby time counting unit
453: standby time comparison unit
457: operation mode control unit

### EFFECTS OF THE INVENTION

The Internet of Things network system in accordance with the present invention has the following effects.

First, the Internet of Things network system in accordance with the present invention enables the installation and version management of an application of a virtual machine for operating a detection server device to be performed through a fog computing network in response to a request from a manager so that an application specialized for the detection server device can be easily installed or managed through the fog computing network.

Second, the Internet of Things network system in accordance with the present invention enables whether or not there exists an application necessary for operation of the detection server device, and the version state and the operation state of the application to be tested through a fog computing network, and then enables the application to be installed in the virtual machine so that the quality of services of the application can be ensured.

Third, the Internet of Things network system in accordance with the present invention enables an operation mode of the detection server device to be controlled based on the operation state of the detection server device so that energy consumption can be reduced in the Internet of Things network environment where a vast amount of data is processed.

### DESCRIPTION OF THE PREFERRED EMBODIMENTS

A relay method of a cloud server in accordance with the present invention will be described hereinafter in more detail with reference to the accompanying drawings.

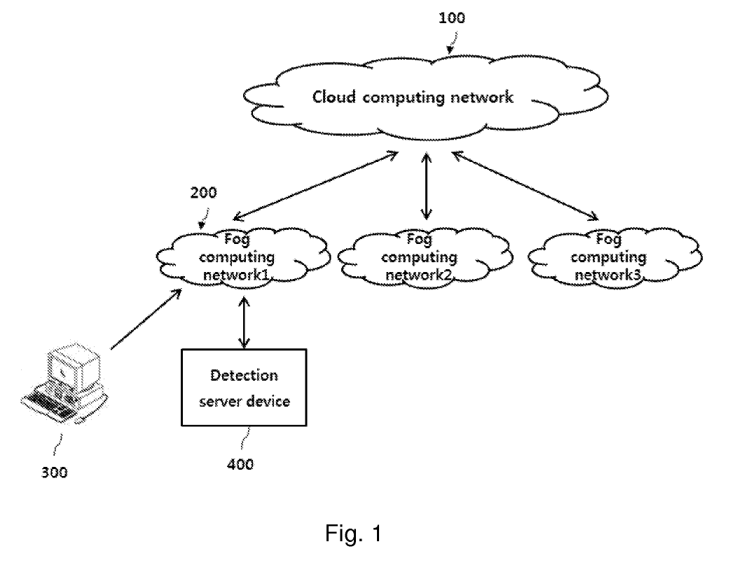

FIG. 1 is a functional block diagram showing an Internet of Things network system in accordance with the present invention.

Referring to FIG. 1, more specifically, a plurality of fog computing networks 1, 2 and 3 200 are distributedly disposed, and a cloud computing network 100 exists at an upper position of the plurality of fog computing networks 200.

The fog computing network 200 provides a memory, a computing resource, or an application to a detection server device 400 used by a user in response to a request from a user terminal 300. In other words, if there is a request from the user terminal 300 for a memory, a computing resource, or an application that is necessary to operate the detection server device 400, a fog computing network 200 which is connected to the user terminal 300 in proximity to the user terminal 300 determines whether or not there exists the memory, the computing resource, or the application, which has been requested by the user terminal 300.

If the memory, the computing resource, or the application, which has been requested by the user terminal 300 exists in the fog computing network 200, the fog computing network 200 is allocated with the memory or computing resource to create a virtual machine that operates the application. On the contrary, if the memory, the computing resource, or the application, requested by the user terminal 300 do not exist in the fog computing network 200, the fog computing network 200 requests a corresponding memory or computing resource and a corresponding application from a cloud computing network which is at an upper position of the fog computing network 200, and creates a virtual machine.

As such, the fog computing network 200 which is positioned in proximity to the user terminal or the detection server device creates the virtual machine so that a resource can be used which is positioned in proximity to user terminal or the detection server device and a load according to the transmission/reception and processing of data can be prevented in an Internet of Things network environment in which a vast amount of data is processed.

In addition, virtual machines using an application that is the same as or similar to the application used in the user terminal or the detection server device are created in the fog computing network 200 which is positioned in proximity to the user terminal or the detection server device. Thus, an application specialized for the user terminal or the detection server device can be easily installed or managed through the fog computing network 200.

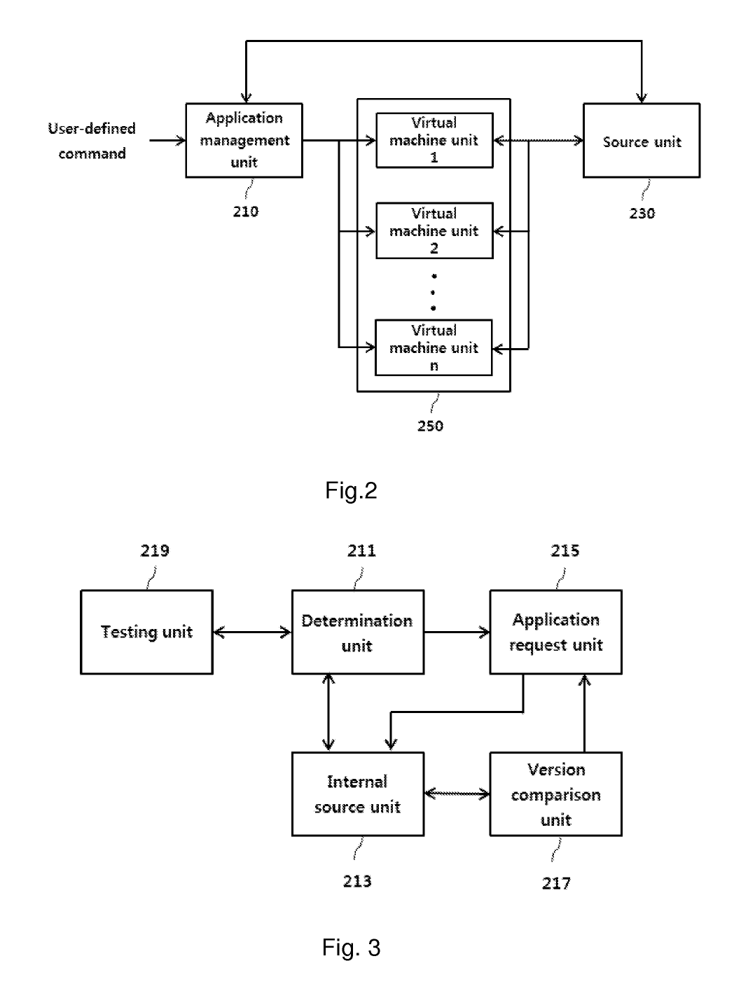

FIG. 2 is a functional block diagram showing a fog computing network in accordance with an embodiment of the present invention.

Referring to FIG. 2, more specifically, the application management unit 210 determines whether or not the application requested by the user terminal exists in the application management unit 210 when the application management unit 210 receives a user-defined command necessary for requesting the application from the user terminal.

If there is determined that the application requested by the user terminal does not exist in the application management unit 210, the application management unit 210 requests the application requested by the user terminal from a source unit 230. The source unit 230 stores an application which is used or was used in the fog computing network.

The source unit 230 compares an application list which has been previously stored therein with the requested application and determines whether or not the requested application exists in the stored application list. If there is determined that the requested application exists in the stored application list, the source unit 230 provides the requested application to the application management unit 210.

On the contrary, if there is determined that the requested application does not exist in the stored application list, the source unit 230 requests the application from the cloud computing network, receives the requested application from the cloud computing network, and stores the received application therein and simultaneously provides the requested application to the application management unit 210.

Meanwhile, if it is determined that the application requested by the user terminal exists in the application management unit 210, the application management unit 210 confirms a version of the requested application existing therein and a version of the same application as the requested application, which is stored in the source unit 230 and determines whether or not the version of the requested application existing in the application management unit 210 is a new version. If there is determined that the version of the requested application existing in the application management unit 210 is not a new version, the application management unit 210 requests a new version of the requested application from the source unit 230. The source unit 230 connects to the cloud computing network periodically and monitors whether or not the version of the application stored in the source unit 230 is a new version. If the version of the application stored in the source unit 230 is not a new version, the source unit 230 receives an application of a new version from the cloud computing network and stores the received application therein.

The application management unit 210 performs a test to determine whether or not the requested application is normally operated, and then provides the requested application to a virtual machine unit 250. The virtual machine unit 250 creates a plurality of virtual machines depending on a task requested by the user terminal, and executes a requested application corresponding to each virtual machine to operate each virtual machine. Each of the virtual machines requests detection information necessary for each virtual machine from the detection server device, and receives the detection information from the detection server device to store and process the received detection information.

FIG. 3 is a functional block diagram showing one example of an application management unit in accordance with the present invention.

Referring to FIG. 3, more specifically, when a determination unit 211 receives a user-defined command necessary to request an application from the user terminal, the determination unit 211 determines whether or not the requested application exists in an internal source unit 213. The determination unit 211 compares an application list of the internal source unit 213 with the requested application and determines whether or not the requested application exists in the application list of the internal source unit 213.

If it is determined that the requested application does not exist in the application list, an application request unit 215 transmits a message for requesting the requested application to the source unit 230.

On the other hand, if it is determined that the requested application exists in the application list of the internal source unit 213, a version comparison unit 217 inquires whether or not a version of the requested application stored in the internal source unit 213 is a new version. If the version of the requested application stored in the internal source unit 213 is not a new version, the internal source unit 213 receives the requested application of a new version from the source unit 230 through the application request unit 215.

The determination unit 211 provides the requested application to a testing unit 219, and the testing unit 219 performs a test to determine whether or not the requested application is normally operated using sample detection information. As a result of the test, if it is determined that the requested application is normally operated, the determination unit 211 provides the requested application to the virtual machine.

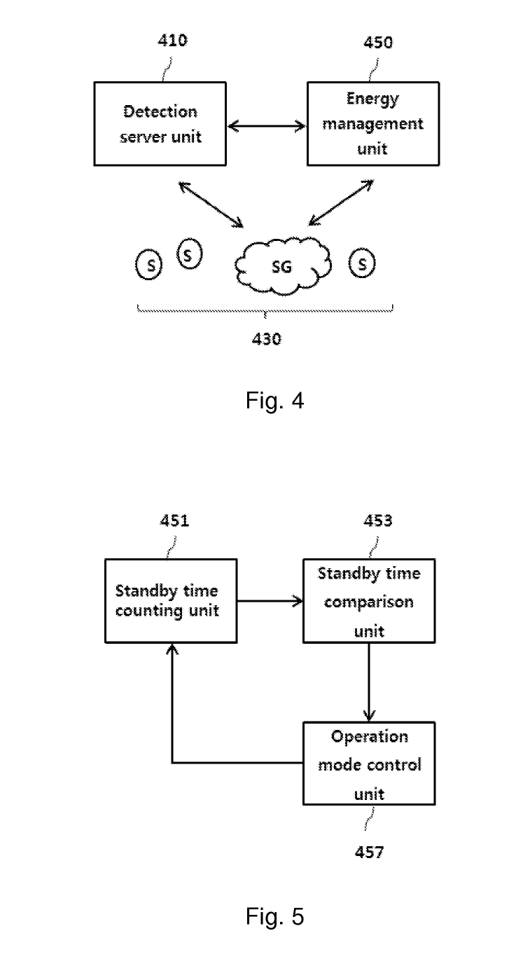

FIG. 4 is a functional block diagram showing one example of a detection server device in accordance with the present invention.

Referring to FIG. 4, more specifically, the detection server device 400 includes a detection server unit 410 for selectively providing detection information collected by a plurality of detection sensors 430 disposed in a thing to the virtual machine if there is a request from the virtual machine for the detection information.

Herein, the detection sensor 430 acquires detection information needed by the virtual machine. For example, the detection sensor 430 can use various kinds of detection sensors including environmental sensors such as a temperature sensor, a lighting sensor, a moisture sensor, and the like, and body information detection sensors such as a body temperature sensor, a heart rate monitoring sensor, a blood pressure monitoring sensor, and the like.

Herein, the detection sensor 430 may be configured as separate sensors or as a sensor group consisting of a plurality of sensors. Each sensor or sensor group is allocated with an IP address and is connected to the detection server unit 410. When the detection server unit 410 receives a request message for detection information of a detection sensor allocated with a specific IP address from the virtual machine, it performs a communication with a corresponding detection sensor and provides selectively necessary detection information to the virtual machine.

The virtual machine acquires necessary detection information in real time using a memory, a computing resource and an application which are allocated without intervention of a user, and processes the acquired detection information.

Meanwhile, an energy management unit 450 controls an operation mode of the detection sensor 430 depending on whether or not there is a request from the virtual machine for the detection information and manages the power consumption of the detection sensor 430. The detection sensor 430 has limited energy and computing ability. The energy management unit 450 controls the detection sensor 430 to be operated in an active mode, a standby mode, or an idle mode depending on whether or not there is a request from the virtual machine for the detection information to reduce the energy consumption of the detection sensor.

FIG. 5 is a functional block diagram showing one example of an energy management unit in accordance with the present invention.

Referring to FIG. 5, more specifically, a standby time counting unit 451 counts an active time starting from the time when the detection server unit 410 receives the request message for detection information from the virtual machine, and initializes the active time counted each time the standby time counting unit 451 receives the request message from the detection server unit 410 during the counting of the active time.

A standby time comparison unit 453 compares the counted active time with a first threshold time, and determines whether or not the active time exceeds the first threshold time. In other words, the standby time comparison unit 453 determines whether or not the time when the standby time counting unit 451 does not receive the request message from the detection server unit exceeds the first threshold time.

If the counted active time exceeds the first threshold time, the operation mode control unit 457 controls the operation mode of the detection sensor to be changed from the active mode to the standby mode. In the meantime, the standby time counting unit 451 counts a standby time starting from the time when the operation mode of the detection sensor is changed from the active mode to the standby mode, and the standby time comparison unit 453 determines whether or not the counted standby time exceeds a second threshold time. If it is determined that the counted standby time exceeds the second threshold time, the operation mode control unit 457 controls the operation mode of the detection sensor to be changed from the standby mode to the idle mode. On the other hand, if the detection server unit 410 receives the request message for detection information from the virtual machine, the operation mode control unit 457 controls the operation mode of the detection sensor to be changed from the standby mode to the active mode.

In the idle mode, the detection sensor determines whether or not there is a change in the detection environment, for example, there is a change in the temperature or moisture of a room if the detection sensor is attached to the room. If it is determined that there is no change in the detection environment, the detection sensor is turned off. On the contrary, if it is determined that the detection sensor detects a change in the detection environment in the idle mode, the detection sensor transmits an alarm signal indicating that there occurs the change in the detection environment to the energy management unit 450. If the energy management unit 450 receives the alarm signal from the detection sensor, it changes the operation mode of the detection sensor from the idle mode to the standby mode.

When the energy management unit 450 receives the alarm signal from the detection sensor, one example of a control method of the operation mode of the detection sensor will be described. The operation mode control unit 457 may control the operation mode of the detection sensor to be changed from the idle mode to the standby mode if the energy management unit 450 receives the alarm signal from the detection sensor. In the standby mode, if the detection server unit 410 receives the request message from the virtual machine, the operation mode control unit 457 control the operation mode of the detection sensor to be changed from the standby mode to the active mode.

When the energy management unit 450 receives the alarm signal from the detection sensor, another example of a control method of the operation mode of the detection sensor will be described. The operation mode control unit 457 may control the operation mode of the detection sensor to be directly changed from the idle mode to the active mode if the energy management unit 450 receives the alarm signal from the detection sensor so that the detection server unit can collect information through the detection sensor and transmit the collected information to the virtual machine.

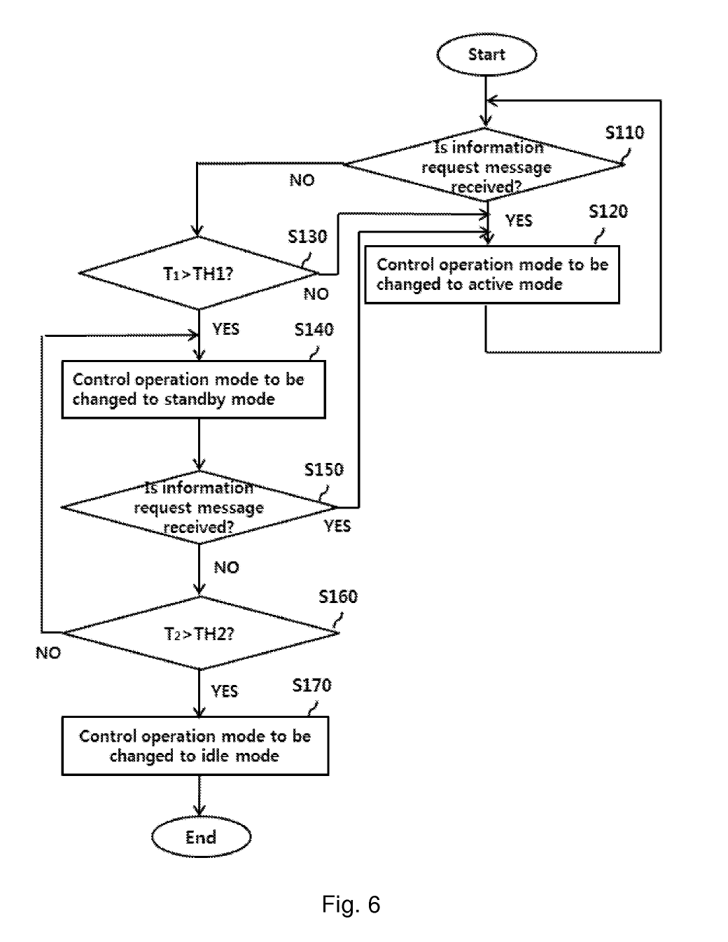

FIG. 6 is a flow chart showing one example of a method for controlling the operation mode of a detection sensor in accordance with the present invention.

Referring to FIG. 6, more specifically, it is determined whether or not the detection server unit receives an information request message from the virtual machine (S110). If it is determined that the detection server unit receives the information request message from the virtual machine, the operation mode control unit controls the operation mode of the detection sensor to be changed to the active mode (S120). In the active mode, the detection sensor acquires detection information in the detection environment and transmits the acquired detection information to the virtual machine.

On the contrary, if it is determined that the detection server unit does not receive the information request message from the virtual machine, the standby time counting unit counts an active time starting from the time when the detection server unit receives the information request message from the virtual machine, and determines whether or not the counted active time exceeds the first threshold time (S130). If the detection server unit receives the information request message within the first threshold time, the counted active time is initialized, and the standby time counting unit re-counts the active time starting from the time when the detection server unit receives the information request message from the virtual machine. If it is determined that the counted active time exceeds the first threshold time, the operation mode control unit controls the operation mode of the detection sensor to be changed from the active mode to the standby mode (S140). In the standby mode, a detection function of the detection sensor, i.e., a function of acquiring the detection information on the detection environment becomes “OFF”, and only a function of perform a communication with the detection server unit becomes “ON”.

After the change of the operation mode of the detection sensor to the standby mode, it is determined whether or not the detection server unit receives an information request message from the virtual machine (S150). If it is determined that the detection server unit receives the information request message from the virtual machine, the operation mode control unit controls the operation mode of the detection sensor to be changed from the standby mode to the active mode (S120). On the contrary, after the change of the operation mode of the detection sensor to the standby mode, the standby time counting unit counts a standby time when the detection server unit does not receive the information request message from the virtual machine, and determines whether or not the counted standby time exceeds the second threshold time (S160).

If it is determined that the counted standby time exceeds the second threshold time, the operation mode control unit controls the operation mode of the detection sensor to be changed from the standby mode to the idle mode (S170). In the idle mode, the detection function and the communication function are controlled to become “OFF”.

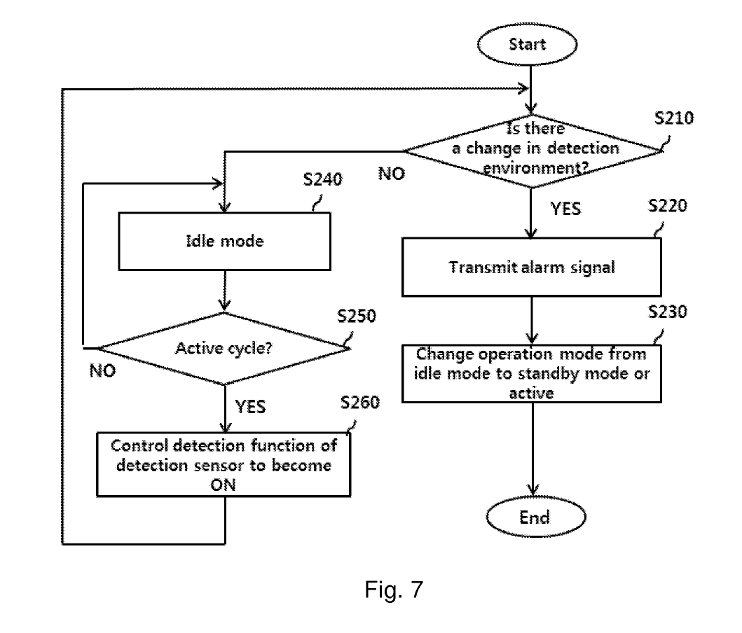

FIG. 7 is a flow chart showing one example of a method for controlling an idle mode of a detection sensor in accordance with the present invention.

Referring to FIG. 6, more specifically, after the change of the operation mode of the detection sensor to an initial idle mode, the communication function of the detection sensor becomes “OFF” and only the detection function of the detection sensor becomes “ON” so that it is determined whether or not a change in the detection environment is detected in a place where the detection sensor is installed (S210). If it is determined that a change in the detection environment is detected, the detection function of the detection sensor becomes “ON” and the detection sensor transmits an alarm signal indicating that there occurs the change in the detection environment to the operation mode control unit (S220).

If the operation mode control unit receives the alarm signal from the detection sensor, it controls the operation mode of the detection sensor to be changed from the idle mode to the standby mode or the active mode (S230).

On the contrary, if it is determined that a change in the detection environment is not detected, the detection sensor is operated in the idle mode in which the detection function and communication function become “OFF” (S240). In the idle mode, it is determined whether or not the detection sensor is in an active cycle (S250). If it is determined that the detection sensor is in the active cycle, the detection function of the detection sensor becomes “ON” to determine whether or not there is a change in the detection environment (S260).

Meanwhile, the embodiments of the present invention as described above can be constructed by a program that can be executed in a computer and can be implemented in a universal digital computer that operates the program using a computer-readable recording medium.

The computer-readable recording medium includes a storage medium such as a magnetic storage medium (e.g., ROM, floppy disk, hard disk, or the like), an optical reading medium (e.g., CD-ROM, DVD, or the like), and a carrier wave (e.g., transfer through the Internet).

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

What is claimed is:

1. An Internet of Things network system, comprising:
a fog computing network in which an application is implemented; and
a detection server device including a plurality of detection sensors connected thereto and configured to transmit information collected to the fog communicating network in response to a request for the application.

2. The Internet of Things network system according to claim 1, wherein the fog computing network comprises:
a source unit configured to storing an application;
an application management unit configured to, if there is a request from a user terminal for the application, test the implementation of the requested application; and
a virtual machine unit configured to receive the requested application from the application management unit, and receive information from the detection server device to implement the requested application.

3. The Internet of Things network system according to claim 2, wherein the application management unit comprises:
an internal source unit configured to store an application therein;
a determination unit configured to determine whether or not the requested application exists in the internal source unit, and provide the requested application to a virtual machine in which the requested application is executed
an application request unit configured to request the requested application from the source unit if it is determined that the requested application does not exist in the internal source unit.

4. The Internet of Things network system according to claim 3, wherein the application management unit comprises a version comparison unit configured to compare a version of the requested application that exists in the internal source unit with a new version of the requested application that is stored in the source unit, and
wherein the version comparison unit requests the new version of the requested application from the source unit through the application request unit if the version of the requested application existing in the internal source unit is different from the new version of the requested application stored in the source unit.

5. The Internet of Things network system according to claim 4, wherein the application management unit further comprises a testing unit configured to perform a test to determine whether or not the requested application is normally operated, and
wherein the determination unit provides the requested application to the virtual machine after the completion of the test.

6. The Internet of Things network system according to claim 3, wherein the virtual machine unit receives the requested application from the application management unit, and then periodically receives information on a new version of the requested application from the source unit.

7. The Internet of Things network system according to claim 6, wherein the virtual machine unit receives the new version of the requested application from the application management unit or the source unit when the virtual machine unit receives the information on the new version of the requested application from the source unit.

8. The Internet of Things network system according to claim 1, further comprising a cloud computing network that exists at an upper position of a plurality of fog computing networks that are distributed,
wherein if the application does not exist in the fog computing network, the fog computing network receives the application from the cloud computing network.

9. The Internet of Things network system according to claim 1, wherein the detection server device comprises:
a plurality of detection sensors attached to things; and
a detection server unit connected to the detection sensors, the detection server unit being configured to control the plurality of detection sensors to selectively perform a detection operation thereof in response to a request for the application to collect information and configured to transmit the collected information to a virtual machine unit.

10. The Internet of Things network system according to claim 9, wherein each of the plurality of detection sensors is allocated with an individual IP address, or the plurality of detection sensors are divided into each group so that each sensor group is allocated with an IP address.

11. The Internet of Things network system according to claim 9, wherein the detection server device further comprises an energy management unit configured to implement the operation of the detection sensor in any one of an active mode, a standby mode, and an idle mode depending on whether or not there is a request from the virtual machine unit for information to control the energy consumption of the detection sensor.

12. The Internet of Things network system according to claim 11, wherein the energy management unit implements the operation of the detection sensor in the active mode to collect detection information through the detection sensor and transmits the collected the detection information to the virtual machine unit if there is a request from the virtual machine unit for information.

13. The Internet of Things network system according to claim 12, wherein the energy management unit implements the operation of the detection sensor in the standby mode to wait a re-detection command from the detection server unit and controls the collection of the detection information by the detection sensor to be stopped if there is no request from the virtual machine unit for information during a first threshold time.

14. The Internet of Things network system according to claim 12, wherein the energy management unit implements the operation of the detection sensor in the idle mode if no re-detection command is received during a second threshold time in the standby mode.

15. The Internet of Things network system according to claim 14, wherein when the operation of the detection sensor is implemented in the idle mode, the detection sensor determines whether or not there is a change in detection environment, and if there is no change in the detection environment, the detection sensor is turned off.

16. The Internet of Things network system according to claim 15, wherein the energy management unit controls the operation mode of the detection sensor to be changed to the standby mode if there is a change in the detection environment.

17. The Internet of Things network system according to claim 16, wherein the energy management unit turns on the detection sensor periodically to determine whether or not there is a change in the detection environment.

18. A detection server device configured to transmit detection information to a fog communicating network in response to a request for an application from the fog computing network in which the application is implemented, the detection server device comprising:
a plurality of detection sensors attached to things; and
a detection server unit connected to the detection sensors, the detection server unit being configured to control the plurality of detection sensors to selectively perform a detection operation thereof in response to a request for the application to collect information and configured to transmit the collected information to a virtual machine unit; and
an energy management unit configured to implement the operation of the detection sensor in any one of an active mode, a standby mode, and an idle mode depending on whether or not there is a request from the virtual machine unit for information to control the energy consumption of the detection sensor.

19. The detection server device according to claim 18, wherein the energy management unit implements the operation of the detection sensor in the active mode to collect detection information through the detection sensor and transmits the collected the detection information to the virtual machine unit if there is a request from the virtual machine unit for information.

20. The detection server device according to claim 18, wherein the energy management unit implements the operation of the detection sensor in the standby mode to wait a re-detection command from the detection server unit and controls the collection of the detection information by the detection sensor to be stopped if there is no request from the virtual machine unit for information during a first threshold time.

21. The detection server device according to claim 18, wherein the energy management unit implements the operation of the detection sensor in the idle mode if no re-detection command is received during a second threshold time in the standby mode.

22. The detection server device according to claim 21, wherein when the operation of the detection sensor is implemented in the idle mode, the detection sensor determines whether or not there is a change in detection environment, and if there is no change in the detection environment, the detection sensor is turned off.

23. The detection server device according to claim 22, wherein the energy management unit controls the operation mode of the detection sensor to be changed to the standby mode if there is a change in the detection environment.

24. The detection server device according to claim 23, wherein the energy management unit turns on the detection sensor periodically to determine whether or not there is a change in the detection environment.
